(19) United States
(12) Patent Application Publication
(10) Pub. No.: US 2020/0034805 A1
(43) Pub. Date: Jan. 30, 2020

(54) METHOD FOR PROVIDING USER INTERFACE FOR OVERSEAS REMITTANCE

(71) Applicant: SODACREW INC., Seoul (KR)

(72) Inventors: Yun Se LEE, Seoul (KR); Richard Jin KIM, Seoul (KR)

(73) Assignee: SODACREW INC., Seoul (KR)

(21) Appl. No.: 16/589,843

(22) Filed: Oct. 1, 2019

Related U.S. Application Data
(63) Continuation of application No. PCT/KR2017/006660, filed on Jun. 23, 2017.

(30) Foreign Application Priority Data
May 18, 2017 (KR) 10-2017-0061605

(51) Int. Cl. G06Q 20/10; G06Q 40/02

(52) U.S. Cl. CPC G06Q 20/10; G06Q 40/02

(57) ABSTRACT

Disclosed is a method for providing a user interface for overseas remittance between a first country and a second country. The method includes displaying the first country and the second country; displaying a first user interface for setting a remittance amount; displaying a second user interface for setting a received amount; receiving a user input to one of the first user interface and the second user interface; calculating an amount corresponding to the other user interface from an amount corresponding to the one user interface; and displaying the calculated amount in the other user interface.

### CROSS-REFERENCE TO RELATED APPLICATIONS

The present application is a continuation of International Patent Application No. PCT/KR2017/006660, filed Jun. 23, 2017, which is based upon and claims the benefit of priority to Korean Patent Application No. 10-2017-0061605, filed on May 18, 2017. The disclosures of the above-listed applications are hereby incorporated by reference herein in their entirety.

### BACKGROUND

Embodiments of the inventive concept described herein relate to a method of providing a user interface for overseas remittance.

Fintech is a compound word of finance and technology and collectively refers to change of financial services and industry via convergence of finance and IT. Regarding the changes in financial services, technology-based financial services provide financial services differentiated from existing financial techniques by utilizing new IT technologies such as mobile, SNS, and big data. Regarding the changes in the industry, innovative non-financial firms offer financial services such as payments directly to users, using their technology. The convergence trend of IT and finance is spreading all over the world. Thus, cross-border commerce is on the rise, and financial transactions via online and mobile are further increasing.

### SUMMARY

Embodiments of the inventive concept provide a method for providing a user interface for overseas remittance.

The purposes to be achieved by the inventive concept are not limited to the purpose mentioned above. Still other purposes not mentioned will be clearly understood by those skilled in the art from the following description.

According to an exemplary embodiment, a method for providing a user interface for overseas remittance between a first country and a second country may include displaying the first country and the second country; displaying a first user interface for setting a remittance amount; displaying a second user interface for setting a received amount; receiving a user input to one of the first user interface and the second user interface; calculating an amount corresponding to the other user interface from an amount corresponding to the one user interface; and displaying the calculated amount in the other user interface.

Further, each of the first user interface and the second user interface may include a jog bar for receiving a touch input or a sliding input of an amount in a predefined range.

Further, the method may further include receiving an input for changing an amount displayed in one of the first user interface and the second user interface; calculating a remittance fee corresponding to the changed amount; and changing a display of at least one of the first user interface and the second user interface based on an amount of the calculated remittance fee.

Further, the method may further include displaying a graph representing fluctuations of an exchange rate between a currency of the first country and a currency of the second country for a predefined period; displaying, in the graph, one or more time points at which the user performed remittances; and displaying information about an remittance amount and an exchange rate at the one or more time points.

Further, the method may further include obtaining a target type; obtaining an amount corresponding to the obtained target type; and displaying a cumulative saved remittance fee for a predefined period in a compared manner with the obtained amount.

Further, the method may further include displaying an amount input window and an amount display window; displaying a dropdown box for selecting one of a first mode and a second mode; applying one of the first mode and the second mode based on an user input to the dropdown box; when the first mode is applied, receiving, by the amount input window, a remittance amount from a remitter of the first country to a recipient of the second country in a currency of the first country, and displaying, in the amount display window, an amount to be received by the recipient of the second country in a currency of the second country; and, when the second mode is applied, receiving, by the amount input window, an amount to be received by the recipient of the second country in a currency of the second country, and displaying, in the amount display window, an amount to be remitted by the remitter of the first country in a currency of the first country.

Further, the method may further include, when the first mode is applied, extracting an amount smaller than or equal to a predefined amount from the amount displayed in the amount display window; displaying a button for selecting whether to round-down the extracted amount; and when a selection input of the button is received, remitting the extracted amount round-downed from the amount displayed in the amount display window to the recipient of the second country.

Further, the displaying of the button may include displaying a deposit button for depositing the extracted amount and a donation button for donating the extracted amount. Further, the method may further include when a selection input of the deposit button is received, depositing the extracted amount to the remitter of the first country; and when a selection input of the donation button is received, donating the extracted amount.

Further, the method may further include sequentially obtaining remittance histories of other remitters; removing personal information from each remittance history to generate a displayed remittance history; and sequentially displaying the generated displayed remittance histories.

Other details of the inventive concept may be included in Detailed Descriptions and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram showing a system for providing an overseas remittance service according to an embodiment.

FIG. 2 is a diagram showing a system for providing an overseas remittance service according to the embodiment shown in FIG. 1.

FIG. 3 is a diagram showing a method of operating a country-specific virtual account according to an embodiment.

FIG. 4 is a diagram illustrating an example of a user interface for providing an overseas remittance service according to a disclosed embodiment.

FIG. 5 to FIG. 9 are diagrams illustrating a user interface for providing an overseas remittance service according to an exemplary embodiment.

FIG. 10 and FIG. 11 are diagrams showing a method for displaying an exchange rate fluctuation according to an embodiment.

FIG. 12 is a diagram illustrating a method of displaying a remittance fee savings status according to an embodiment.

FIG. 13 is a diagram showing an interface for entering an amount according to an embodiment.

### DETAILED DESCRIPTION

Advantages and features of the inventive concept, and methods of achieving them will become apparent with reference to embodiments described below in detail in conjunction with the accompanying drawings. However, the inventive concept is not limited to the embodiments disclosed below, but may be implemented in various forms. The present embodiments are provided to merely complete the disclosure of the inventive concept, and to merely fully inform those skilled in the art of the inventive concept of the scope of the inventive concept. The inventive concept is only defined by the scope of the claims.

The terminology used herein is for the purpose of describing the embodiments only and is not intended to limit the inventive concept. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. The same reference numbers in different figures denote the same or similar elements, and as such perform similar functionality. As used herein, the term “and/or” includes any and all combinations of one or more of the associated listed items. Although “first”, “second”, etc. are used to describe various components, these components are not limited by these terms. These terms are only used to distinguish one component from another. Therefore, a first component mentioned below may be a second component within a technical spirit of the inventive concept.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a term “unit” or “module” means software, or a hardware component such as FPGA or ASIC. The “unit” or “module” performs a specific function. However, the “unit” or “module” is not meant to be limited to the software or hardware. The “unit” or “module” may be configured to reside in an addressable storage medium or may be configured to execute one or more processors. Thus, in an example, the “unit” or “module” may include components such as software components, object-oriented software components, class components, and task components, processes, functions, properties, procedures, subroutines, segments of program code, drivers, firmware, microcode, circuits, data, databases, data structures, tables, arrays and variables. The components and “units” or “modules” may be combined into smaller numbers of components and “units” or “modules” or may be divided into larger numbers of components and “units” or “modules”.

Hereinafter, an embodiment of the inventive concept will be described in details with reference to the accompanying drawings.

In disclosed embodiments, it may be assumed that a Korean remitter performs a remittance to the United States or an American remitter performs remittances to Korea. However, countries related to the remittance are not limited thereto.

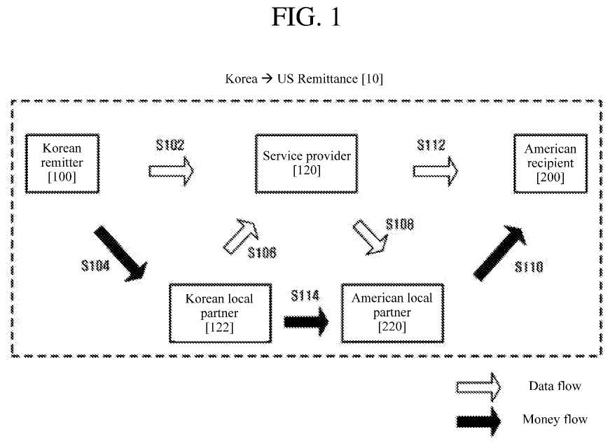

FIG. 1 is a diagram showing a system for providing an overseas remittance service according to an embodiment.

Referring to FIG. 1, there is shown a system 10 that provides an overseas remittance service in which remittance from Korea to the United States may be performed. Regarding the system 10, it is assumed below that a Korean remitter 100 performs a remittance to the United States.

Referring to FIG. 1, the system 10 includes the Korean remitter 100, a service provider 120, a Korean local partner 122, an American recipient 200 and an American local partner 220. The Korean remitter 100, service provider 120, Korean local partner 122, American recipient 200, and American local partner 220 shown in FIG. 1 refer to computing devices or servers that perform each of steps shown in FIG. 1.

For example, the Korean remitter 100 and American recipient 200 may mean clients or computing terminals of the Korean remitter 100 and American recipient 200, respectively. Further, each of the service provider 120, Korean local partner 122 and American local partner 220 may mean a server.

In step S102, the Korean remitter 100 requests a remittance to the American recipient 200 to the overseas remittance service provider 120. In one embodiment, the remittance request may be performed via the Internet.

The service provider 120 may apply a real-time exchange rate to a Korean amount requested by the remitter 100, and convert the Korean amount to an US amount and calculate a remittance fee.

In an embodiment, the service provider 120 may provide the remitter 100 with a result of converting a won based amount that the remitter 100 requests for remittance into a dollar based amount. In another embodiment, the service provider 120 may provide the remitter 100 with a result of converting the dollar based amount that the remitter 100 requests for remittance into the won based amount.

In step S104, the Korean local partner 122 performs money-collection from the Korean remitter 100. For example, the Korean local partner 122 may perform money-collection from at least one account of the remitter 100 using information about the at least one account of the remitter 100.

The information about the at least one account of the remitter 100 may include at least one of a bank, an account number, an account password, a bank ID and password of the remitter 100, but is not limited thereto.

In one embodiment, the remitter 100 may have a deposit for the service provider 120. In this case, the service provider 120 performs the overseas remittance using the deposit of the remitter 100 without performing the money-collection via the Korean local partner 122.

In step S106, when the Korean local partner 122 completes the money-collection from the remitter 100, the Korean local partner 122 may send information to approve the remittance request of the remitter 100 to the service provider 120.

In step S108, the service provider 120 transmits the remittance information about the American recipient 200 to the American local partner 220.

In step S110, the American local partner 220 remits the dollar-based amount corresponding to the won-based amount which the remitter 100 remits to an account of the American recipient 200.

In step S112, the service provider 120 transmits the remittance information of the remitter 100 to the American recipient 200.

In one embodiment, the service provider 120 may deliver a remittance message adapted to a purpose of the remittance to the recipient 200 to the recipient 200.

For example, the remitter 100 may have remitted the money to celebrate the recipient 200's birthday. In this case, the service provider 120 may transmit a birthday card image and a birthday message created by the remitter 100 together with the remittance information.

In one embodiment, the service provider 120 may automatically determine the remittance purpose based on personal information of the remitter 100 or the recipient 200. For example, if the remittance day is a birthday of the recipient 200, the service provider 120 may automatically generate and send a happy birthday message. Alternatively, the service provider 120 may generate a message based on information on the date on which the remittance is made. For example, for Christmas or Mother's Day, an image and message suitable for that date may be automatically generated and sent to the recipient 200.

In another example, the remitter 100 may perform the remittance for payment. In this case, the service provider 120 may transmit information on a payment target together with the remittance information.

In another example, the remitter 100 may perform a regular remittance of, for example, allowance or rent. In this case, the service provider 120 may automatically generate a remittance message based on a past remittance history of the remitter 100 and transmit the remittance message together with the remittance information.

In step S114, the Korean local partner 122 may periodically pay the remittance amount for the American local partner 220.

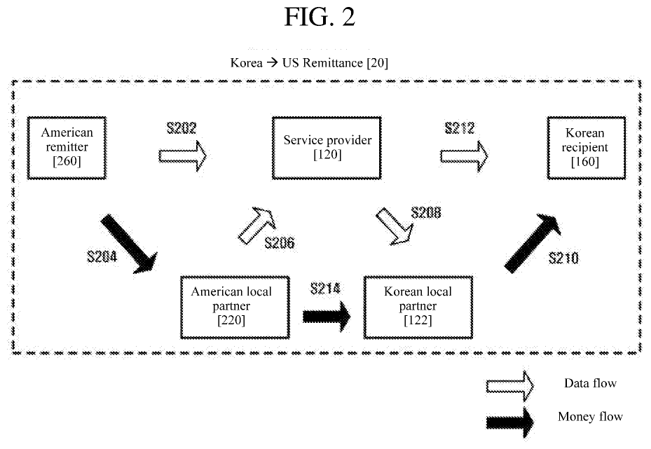

FIG. 2 is a diagram showing a system for providing the overseas remittance service according to the embodiment shown in FIG. 1.

Referring to FIG. 2, a system 20 that provides an overseas remittance service that performs a remittance from the United States to Korea is shown. Regarding the system 20, it is assumed that an American remitter 260 performs a remittance to Korea.

Referring to FIG. 2, the system 20 includes the American remitter 260, the service provider 120, the Korean local partner 122, the Korean recipient 160 and the American local partner 220. Each of the American remitter 260, the service provider 120, the Korean local partner 122, the Korean recipient 160, and the American local partner 220 shown in FIG. 2 represents a computing device or server that performs each step shown in FIG. 2.

For example, the American remitter 260 and Korean recipient 160 mean clients or computing terminals of the American remitter 260 and the Korean recipient 160, respectively. Further, each of the service provider 120, the Korean local partner 122 and the American local partner 220 may mean a server.

FIG. 2 is a view showing another example of a system for providing an overseas remittance service shown in FIG. 1. Although omitted in relation to FIG. 2, the contents described in relation to FIG. 1 may be applied to the system that provides the overseas remittance service shown in FIG. 2.

In step S202, the American remitter 260 requests a remittance to the Korean recipient 160 to the overseas remittance service provider 120.

In step S204, the American local partner 220 performs money-collection from the American remitter 260.

In step S206, the American local partner 220 transmits information to approve the remittance request from the remitter 260 to the service provider 120 when the money-collection from the remitter 260 is completed.

In step S208, the service provider 120 transmits remittance information about the Korean recipient 160 to the Korean local partner 122.

In step S210, the Korean local partner 122 remits a won-based amount corresponding to a dollar-based amount remitted by the remitter 260 to an account of the Korean recipient 160.

In step S212, the service provider 120 transmits remittance information of the remitter 260 to the Korean recipient 160.

In step S214, the American local partner 220 periodically pays the remittance amount for the Korean local partner 122.

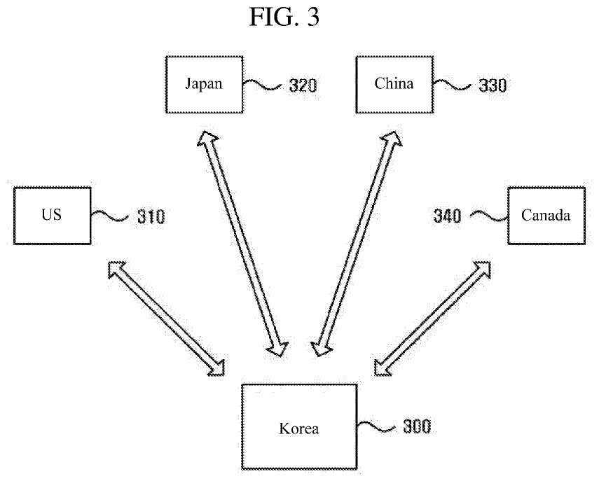

FIG. 3 is a diagram illustrating a method of operating a country-specific virtual account according to an embodiment.

According to the embodiment shown in FIG. 1 and FIG. 2, the Korean remitter 100 may exchange and remit a predetermined amount to each country at a relatively small remittance fee.

Further, an operator may directly enter into an agreement with a bank of each country, or an agreement with an overseas partner doing business with a bank of each country, to create a virtual personal account in each country

Referring to FIG. 3, the Korean remitter 100 may have a Korean real account 300 and may have virtual accounts 310 to 340 created in each country.

The countries mentioned in FIG. 3 are provided by way of example. A type and number of countries in which the virtual account according to the disclosed embodiments may be created are not limited thereto.

Each of the virtual accounts 310 to 340 of countries may be an account actually opened through an agreement with each bank, or may be generated by virtually dividing an operator's account.

The Korean remitter 100 may store an asset in countries in various currencies by remitting at least a portion of an amount of the account 300 to virtual accounts assigned thereto.

The remittance amount to the overseas virtual account may be remitted back to the domestic account 300, or may be remitted to another account in another country.

In one embodiment, the remitter 100 may remit a predefined amount to the American account 310 when the dollar-based exchange rate is low, and thus deposits the dollar-based amount therein. When necessary, the remitter 100 may remit an amount to another person's account in US.

Further, when an exchange rate for each country's currency becomes a predetermined specific exchange rate, a function to automatically exchange a specific amount to the corresponding currency and remit the amount to the virtual account of the country may be provided to the remitter 100.

A server of the operator may calculate an exchange rate of each country in real time. If the exchange rate of a specific currency drops below a predefined threshold, the server may automatically exchange an amount to that currency and may remit the amount to the virtual account of that country. Thus, the remitter 100 may obtain a gain due to the exchange rate difference.

In one embodiment, a user client of the remitter 100 may provide an user interface to allow the user to easily manage a plurality of virtual accounts by summarizing and displaying amounts deposited in the account 300 of the remitter 100 and virtual accounts 310 to 340 of countries of the remitter 100, and enlarging and displaying a virtual account of a selected country.

Since the overseas remittance method according to the disclosed embodiment has a relatively low remittance fee, the remitter 100 has an effect of easily and freely performing the remittance between virtual accounts of the countries using the user interface provided according to the disclosed embodiment.

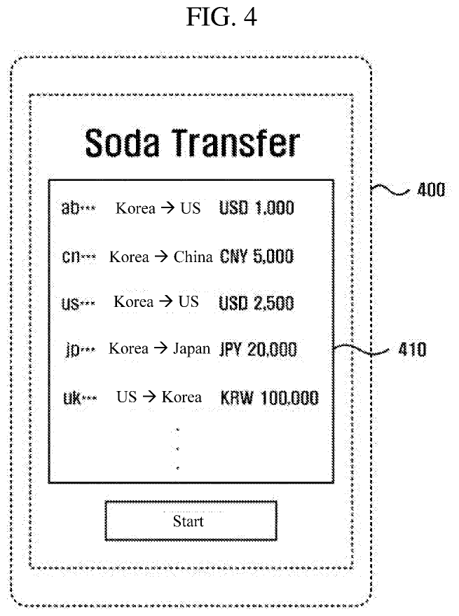

FIG. 4 is a diagram illustrating an example of a user interface for providing an overseas remittance service according to the disclosed embodiment.

In one embodiment, a screen shown in FIG. 4 is displayed on a start screen of the overseas remittance service according to the disclosed embodiment.

A user terminal 400 illustrated in FIG. 4 and below may mean a computing device including at least one processor, or may mean a combination of a computing device and a monitor connected to the computing device.

In an embodiment, the user terminal 400 displays a window 410 displaying a remittance history in real time on a screen.

The window 410 displays, in real time, a remittance history of a user using the overseas remittance service according to the disclosed embodiment. For example, information about the most recent remittance history is displayed at a top or bottom of the window 410. Information on the oldest remittance history among the information on the remittance history displayed in the window 410 is removed from the window 410.

That is, the user terminal 400 continuously displays the latest overseas remittance information in the window 410, and deletes the oldest overseas remittance information among the information displayed in the window 410. For example, the window 410 displays a plurality of overseas remittance information in an ascending or descending order of remittance times. When the window 410 displays a plurality of overseas remittance information in the ascending order, the newest remittance information is displayed at a bottom and the oldest remittance information is displayed at a top and then removed. When the window 410 displays a plurality of overseas remittance information in the descending order, the newest remittance information is displayed at a top and the oldest remittance information is displayed at a bottom and then removed.

In one embodiment, each remittance information includes information on a remittance fee saved by the remitter. For example, information on the remittance fee portion saved by the remitter using the overseas remittance service according to the disclosed embodiment compared to the bank based remittance is included in each remittance information.

A server of an overseas remittance operator connected to the user terminal 400 may process the overseas remittance information generated in real time to generate displayed data that may be displayed on the window 410. For example, distribution of personal information to everyone is prohibited. Thus, a name or ID of the remitter may be omitted or at least a portion thereof may be hidden. Information on a remittance country or a remittance amount may be omitted or at least a portion thereof may be hidden. Thus, personal information leakage may be suppressed.

The server sends the generated displayed data to the user terminal 400. The user terminal 400 sequentially displays the received data in the window 410.

Using the embodiment shown in FIG. 4, the overseas remittance operator may effectively inform a user that many users are using the service in real time.

Information that many users are using the same service may increase the reliability of the service. Thus, according to the disclosed embodiment, the overseas remittance operator may display the window 410 on the start screen of the overseas remittance service, or display the window in a banner form on at least a portion of the screen of the overseas remittance service.

In one embodiment, the displayed data displayed in the window 410 includes data visualizing the remittance fee saved by the remitter in each remittance history.

For example, the displayed data includes information that replaces the remittance fee saved by the remitter with a product that may be purchased in everyday life such as hamburgers or coffee in each remittance history. That is, information on how many hamburgers or coffees can be purchased by the remittance fee saved by the remitter based on each remittance history may be displayed on the window 410.

The price of burgers or coffee may be set with reflecting an average price thereof in the country of the remitter or recipient. A type of the product substituting the saved remittance fees may not be limited thereto. The user may directly set a desired product type and a value of each product.

In an embodiment, the window 410 may indicate whether other users currently perform more frequent remittances compared to a normal average. For example, when the users currently perform more frequent remittances compared to a normal average, this may indicate that a current exchange is beneficial to the user. Accordingly, the user may determine whether to perform a remittance based on the information displayed in the window 410.

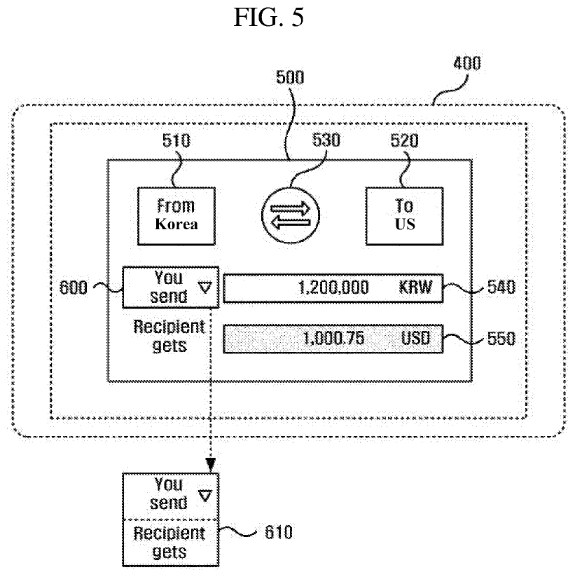

FIG. 5 to FIG. 9 are diagrams showing a user interface for providing an overseas remittance service according to an embodiment.

Referring to FIG. 5, an overseas remittance window 500 shown in the user terminal 400 is shown. FIG. 5 to FIG. 9 illustrate the user interface displayed on the overseas remittance window 500.

In an embodiment, the user terminal 400 receives information including account numbers of a remitter and a recipient.

The user terminal 400 may verify the input account numbers. During the account number verification, the user terminal 400 may deactivate the screen to prevent other manipulations thereon.

Referring to FIG. 5, the overseas remittance window 500 has country indicators 510 and 520, a switching button 530, an amount input window 540 and an amount display window 550.

In one embodiment, a country of the remitter is displayed in the left country indicator 510, while a country of the recipient is displayed in the right country indicator 520.

In one embodiment, the country of the remitter and the country of the recipient may be automatically entered into the country indicators 510 and 520 respectively. For example, the left country indicator 510 may automatically indicate the country in which the user is located. The right country indicator 520 may automatically indicate a target country subjected to frequent remittances by the user, a target country subjected to previous remittance by the user, or a target country subjected to frequent remittances by users of the overseas remittance service according to the disclosed embodiment.

In one embodiment, the user terminal 400 or the server providing the overseas remittance service analyzes the user's remittance pattern from the user's transaction history. For example, the user terminal 400 or the server providing the overseas remittance service may determine from the analysis result that the user remits a specific amount to a specific person on a specific day of each month.

The user terminal 400 provides a notification to the user on a date on which the user is expected to perform a remittance based on the determination result. The user terminal 400 may automatically display and suggest expected remittance information to the user.

In one embodiment, the user terminal 400 may provide a fast remittance service to display remittance histories that the user previously performed, and receive a selected one among the displayed remittance histories from the user and guide the user to remit the same amount to the same recipient as those of the selected remittance history.

Further, after displaying the same amount and the same recipient as those of the selected remittance history, the user terminal 400 may allow the user to partially adjust the remittance information. In one embodiment, the user terminal 400 may allow an amount to be automatically input based on the remittance amount of the selected remittance history, and allow an amount to be automatically input based on the received amount of the recipient of the selected remittance history.

In an embodiment, after the automatic inputting of the remittance amount or the receiving amount, the user terminal 400 calculates and displays the received amount or the sending amount based on the current exchange rate and the remittance fee. The user terminal 400 may display a user interface that allows the user to directly adjust an amount varying based on a change in the exchange rate or the remittance fee. For example, the user terminal 400 may display a jog bar configured to allow the user to partially adjust the sending or receiving amount, and then receive a user input via the jog bar.

In one embodiment, after storing a specific recipient and amount, the user terminal 400 may allow the user to quickly perform a remittance based on the stored information. The amount may be stored based on the sending amount or may be stored based on the receiving amount.

In one embodiment, the user selects each country indicator 510 and 520 and receives a list including one or more countries. The user selects a desired country from the list as provided.

In one embodiment, the user selects each country indicator 510 and 520 and directly enters a country name therein.

The switching button 530 is a button for allowing the user to conveniently change country names displayed on the left and right country indicator 510 and 520, respectively. When the user terminal 400 receives a selection input into the switching button 530 from the user, the user terminal 400 exchanges the countries displayed on the left and right country indicators 510 and 520, respectively, and displays the changed countries on the left and right country indicators 510 and 520, respectively.

Thus, when the user terminal 400 receives the selection input into the switching button 530 from the user, the user terminal 400 exchanges the country of the remitter and the country of the recipient.

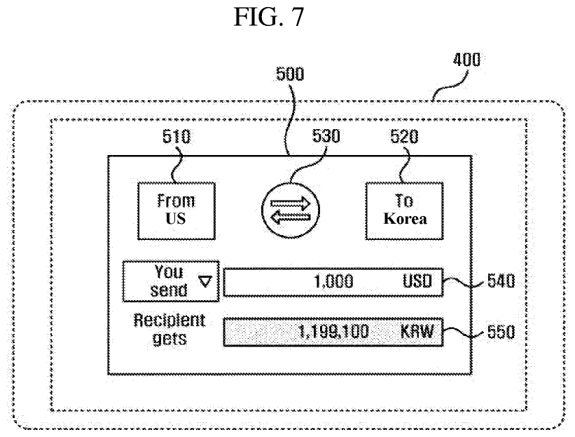

An example where the countries of sending and receiving the money are exchanged with each other via the switching button 530 in the embodiment shown in FIG. 5 is shown in FIG. 7.

The amount input window 540 receives an amount that the user wants to send in a currency of the country displayed on the left country indicator 510.

When the amount entered in the amount input window 540 is remitted to the country indicated by the right country indicator 520, the amount display window 550 may allow an amount received by the recipient to be displayed in a currency of the country indicated by the right country indicator 520.

In one embodiment, the amount display window 550 may be deactivated so that confusion of the user is avoided and the user cannot enter an amount arbitrarily.

Referring to FIG. 5, the overseas remittance window 500 further includes a dropdown box 600 to allow the user to select an amount input scheme.

If the user selects the dropdown box 600, the user terminal 400 displays an expanded dropdown box 610. The user may choose whether to enter the amount the remitter wants to send or the amount the recipient wants to receive on the dropdown box 610.

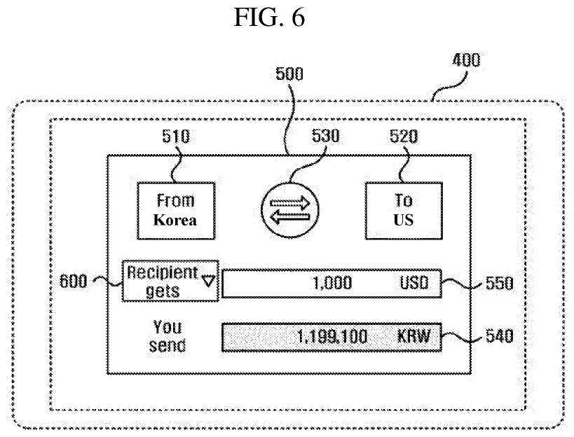

If the user selects “Recipient gets” in FIG. 5, the screen displayed on the user terminal 400 is switched to a screen shown in FIG. 6.

Referring to FIG. 6, the amount input window 540 receives the amount the user wants to send in the currency of the country indicated on the right country indicator 520.

The amount display window 550 displays an amount input to the amount input window 540 in the currency of the country displayed in the left country indicator 510 at a corresponding amount to an amount to be received by the recipient of the country shown in the right country indicator 520.

As described with reference to FIG. 5, the user may select one of the amount input scheme shown in FIG. 5 and the amount input scheme shown in FIG. 6 using the drop-down box 600.

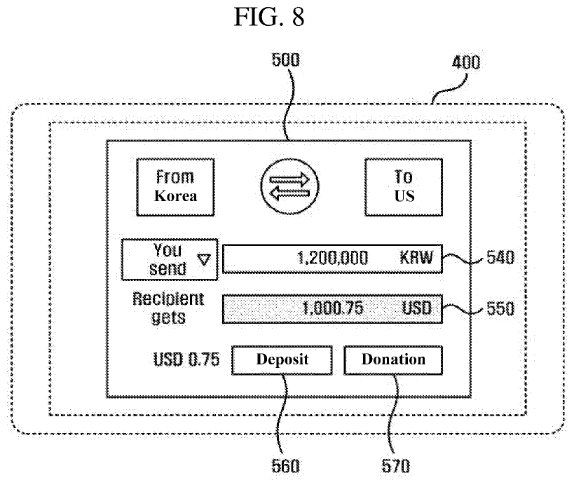

Referring to FIG. 8, there is shown an example of a method for processing a balance during overseas remittance according to the disclosed embodiment.

Referring to FIG. 8, the user has entered 1.2 million Korean won in the amount input window 540. The user terminal 400 may indicate in the amount display window 550 that 1000.75 US dollars excluding the exchange fee and remittance fee would be deposited to the recipient in US at the time of remittance.

If the user wants to remit 1000 US dollars to the recipient, 0.75 US dollar may be an unnecessary balance. Accordingly, the user terminal 400 may provide the user with an option to deposit to the user's account or donate a small amount less than a predefined reference amount.

Referring to FIG. 8, the overseas remittance window 500 displays the automatically calculated balance. A deposit button 560 and a donate button 570 for user selection are displayed in the overseas remittance window 500.

When the user selects the deposit button 560, the user terminal 400 transmits information about the user's selection to the server. The server may deposit the balance to the user's account.

In one embodiment, when the user selects the deposit button 560, the user terminal 400 transmits information about the user's selection to the server. After remitting an amount including the balance to the United States, the server may deposit the balance into the user's American virtual account.

In one embodiment, the server may remit, to the United States, only an amount excluding an amount corresponding to the balance, and may deposit the balance (won-based amount) in the user's account.

When the user selects the donation button 570, the user terminal 400 sends information about the user's selection to the server. The server may donate the balance.

In one embodiment, after the server remits the amount including the balance to the United States, the server may donate the balance (dollar-based amount) to an organization in US.

In one embodiment, the server may remit only the amount excluding the amount corresponding to the balance to the United States, and then may donate the balance (won-based amount) to the domestic organization.

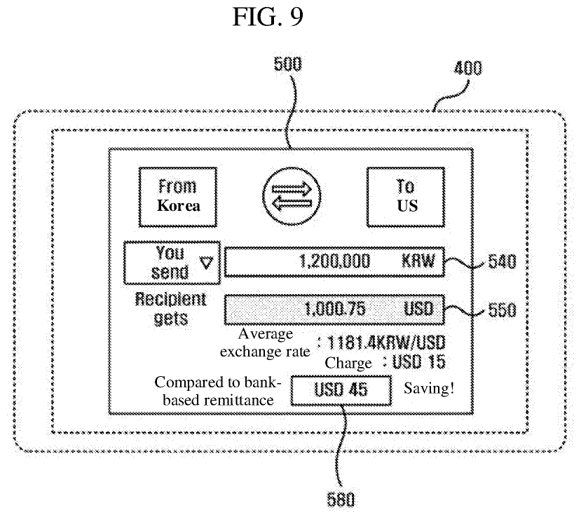

Referring to FIG. 9, the overseas remittance window 500 displays the exchange rate and remittance fee as applied. A window 580 displays a comparison result between the bank based average remittance fee and the remittance fee of the overseas remittance service according to the disclosed embodiment.

In one embodiment, the window 580 displays an amount saved when using the overseas remittance service according to the disclosed embodiment, compared to the average bank based remittance fee.

In one embodiment, the window 580 sequentially displays amounts saved when using the overseas remittance service according to the disclosed embodiment compared to remittance fees occurring when using one or more banks.

In one embodiment, when a user's selection of the window 580 is received from the user, the user terminal 400 compares the remittance fee of each bank and the remittance fee of the overseas remittance service according to the disclosed embodiment and displays a comparison result.

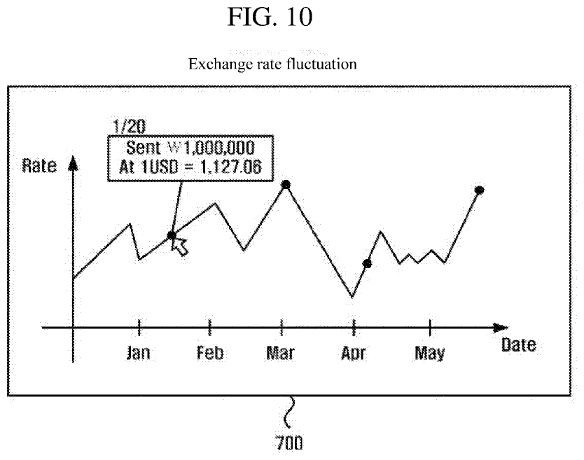

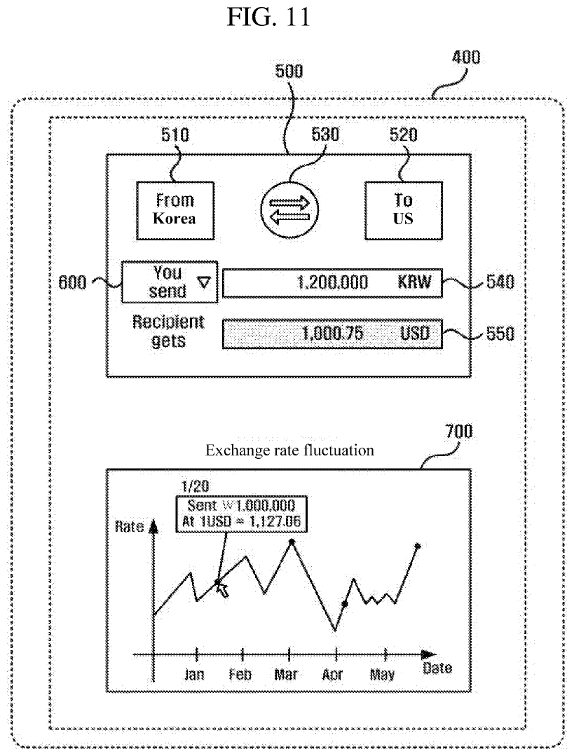

FIG. 10 and FIG. 11 illustrate a method of displaying an exchange rate fluctuation according to an embodiment.

In one embodiment, the user terminal 400 displays a window 700 indicating the exchange rate fluctuation. The exchange rate fluctuation may be displayed in a graphical form showing fluctuations in the exchange rate over a predefined period.

In an embodiment, the graph may display time points when the user previously performed remittances. For example, the point in time when the user performed the remittance may be displayed in a form of a point on the graph.

When the user selects each point, a remittance time, a remittance amount, and an exchange rate corresponding to each point are displayed. The user may determine whether to perform a remittance and a remittance amount with referring to the exchange rate fluctuation and his remittance time as displayed.

The exchange rate fluctuation window 700 may be provided in a separate screen, as shown in FIG. 10 or may be displayed together with the overseas remittance window 500, as shown in FIG. 11. Referring to FIG. 11, the graph displayed in the exchange rate fluctuation window 700 may show a current time. The user may determine whether to perform the remittance and the remittance amount with referring to the current time point and previous remittance time points as displayed on the graph and the exchange rate fluctuations displayed on the graph.

In an embodiment, the overseas remittance window 500 may further display remittance status of other users. The user may determine whether it is advantageous to currently perform the remittance with referring to the remittance status of other users and the exchange rate fluctuation window 700.

For example, the user may determine whether the exchange rate is expected to fall or rise based on the graph displayed on the exchange rate fluctuation window 700. The user may further refer to other users' remittance status. Then, the user may obtain information on views of the other users about whether it is advantageous to currently perform the remittance.

The number of remittances may be smaller even when the exchange rate is falling. This may indicate that other users determine that the exchange rate will further fall. The number of remittances may be larger even when the exchange rate is rising. This may indicate that other users determine that the exchange rate will further rise.

The server or user terminal 400 may predict the exchange rate change based on the exchange rate fluctuation and remittance status of other users, and then may provide the user with forecast information on the exchange rate change. That is, the server or the user terminal 400 may determine whether the current remittance is advantageous to the user and provide the determination to the user. However, since the information provided to the user is only a prediction, the decision to perform the remittance directly depends on the user. However, based on the user's setting, the server or the user terminal 400 may provide a notification to the user when the exchange rate becomes above or below the predefined reference value.

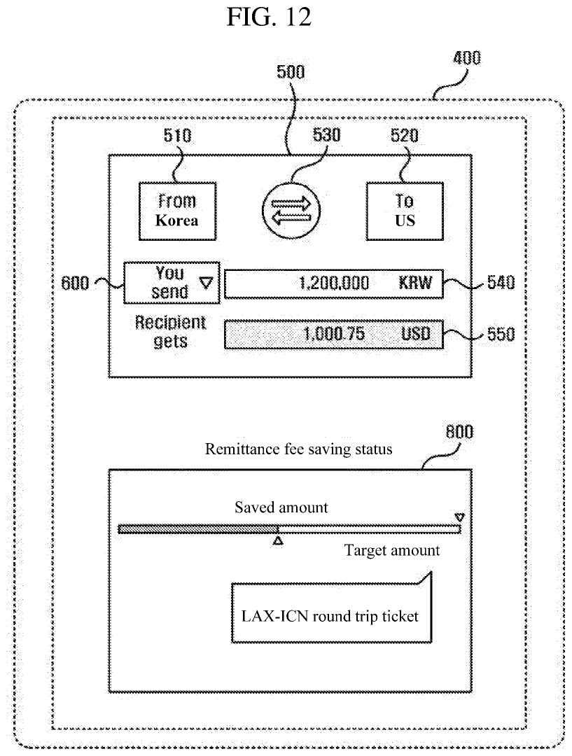

FIG. 12 illustrates a method of displaying a remittance fee saving status according to an embodiment.

In one embodiment, the user terminal 400 displays a remittance fee saving status window 800 for displaying the total amount of the remittance fee saved by the user for a predefined period of time.

The remittance fee saving status window 800 displays a total amount of the remittance fee saved up to a current time. According to an exemplary embodiment, the total saving may be visualized and displayed as shown in a bar graph shown in FIG. 12.

In an embodiment, a target amount set by the user may be displayed in the remittance fee saving status window 800. For example, the target amount may be intended for the user to purchase a round trip ticket. A departure location and destination of the round-trip ticket may be set to be residences of the remitter and the recipient respectively, but may not be limited thereto.

The remittance fee saving status window 800 may display the total amount of the remittance fee saved using the use of the overseas remittance service according to the disclosed embodiment in comparison with the target amount. For example, in the remittance fee saving status window 800, a percentage of the total saved remittance fee compared to the target amount may be displayed numerically or graphically.

In one embodiment, the target amount may be set by the user. A target type (product, ticket and service) corresponding to the target mount may be set by the user.

The user terminal 400 may display an advertisement corresponding to the target type set by the user. For example, if the target type set by the user is a round-trip ticket, the user terminal 400 may display an advertisement about a round-trip ticket between the remitter's residence and the recipient's residence, or display an advertisement related to travel or lodging in each residence.

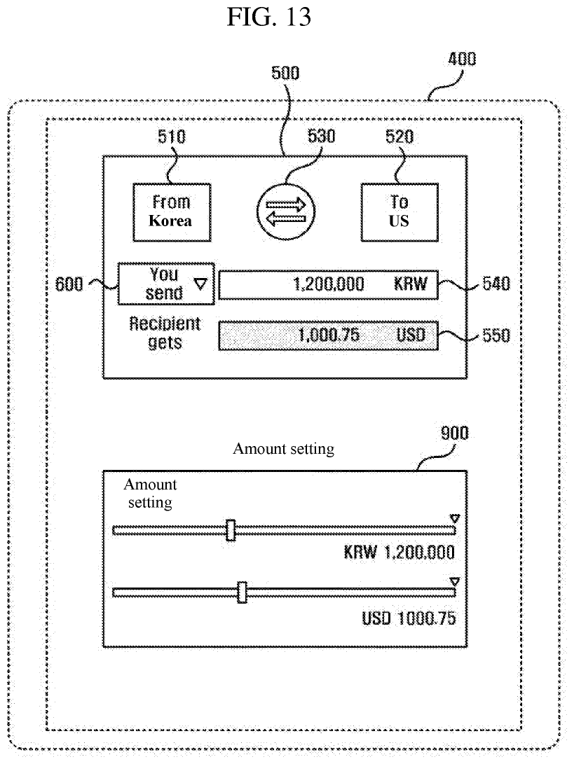

FIG. 13 is a diagram illustrating an interface for inputting an amount according to an embodiment.

Hereinafter, a description will be given of a user interface for determining the amount using a jog bar. The jog bar is presented as an example and the user interface for determining the amount is not limited thereto.

Referring to FIG. 13, an input window 900 displays two jog bars.

In one embodiment, a first jog bar may correspond to an amount to be sent, while a second jog bar may correspond to an amount to be received.

Thus, when manipulating the first jog bar, a value of the second jog bar may be automatically calculated and adjusted. Similarly, when manipulating the second jog bar, a value of the first jog bar may be automatically calculated and adjusted.

One end of the jog bar may correspond to a maximum amount that the user can remit for a predefined period of time. The maximum amount may be set by the user or the service operator.

Therefore, the user may adjust the amount to be sent or the amount to be received using the jog bar. Thus, the user may conveniently check the calculated amount of the received or sending amount using the jog bar.

In one embodiment, a size or ratio of the remittance fee saved by the user may vary based on the amount adjustment on the jog bar. The user terminal 400 may change at least one of a size, shape and color of the jog bar based on the jog bar control to indicate how much the user can save the remittance fee. For example, when the jog bar informs the user of an amount corresponding to the largest remittance fee saving, the jog bar changes to a green. When the jog bar informs the user of an amount corresponding to the smallest remittance fee saving, the jog bar changes to a red.

Thus, the user terminal 400 may provide the user interface to allow the user to conveniently select the desired amount and to select an amount range corresponding to the largest remittance fee saving.

In one embodiment, the overseas remittance service according to the disclosed embodiment may induce the user to recommend the service to other users.

For example, the user may recommend other users to use the overseas remittance service using a messenger service. A discount coupon is provided to the user who recommended the other users when the users who received the recommendation actually join and use the remittance service.

A valid use time of the discount coupon may be set to a predefined period. In this case, the user may apply the discount coupon while using the remittance service within the set valid use period, thereby to obtain a remittance fee discount.

A list of the recommended users may be managed in the user's account. Whether the user as recommended is registered and whether the user as recommended actually uses the remittance service may be checked in the user's account. For example, a list of recommended users, a list of subscribed users, and a list of users who actually used the remittance service may be managed step by step. The user may again send a recommendation message to the users included in the list.

In an embodiment, the user terminal 400 may specifically provide a remittance process to the user. For example, the user terminal 400 may describe in detail and provide to the user, information about an amount that the user wants to remit, information on the recipient who will receive the amount, an amount that the recipient will receive, the remittance fee, and domestic and overseas steps related to the remittance.

Each step of the remittance process may be provided to the user in a picture or graph form or may be provided to the user in a natural language form. In one embodiment, the server or user terminal 400 may store a natural language template for describing the remittance process, and create a natural language based guide statement by replacing only information that can be changed such as the amount, remitter, recipient, date, remittance fee, etc.

The completed guide statement may be provided to the user in various ways, for example, in a text or voice form, so that the user can conveniently grasp the remittance step.

The steps of the method or algorithm described in connection with the embodiment of the inventive concept may be implemented directly in hardware, in a software module executed by the hardware, or by a combination thereof. The software module may reside in RAM (Random Access Memory), ROM (Read Only Memory), EPROM (Erasable Programmable ROM), EEPROM (Electrically Erasable Programmable ROM), flash memory, hard disk, removable disk, CD-ROM, or any form of a computer readable recording medium well known in the art.

In general, for overseas remittance, the actual exchange and remittance between the countries are required. Thus, this takes a lot of time while going through banks of both countries, and takes a lot of remittance fee.

According to the disclosed embodiment, there is an effect that the present approach can greatly reduce the time and remittance fee required for remittance.

According to the disclosed embodiment, there is an effect that the present approach can provide a user interface to allow the user to conveniently select and input a remittance country, a remittance target country, and a remittance amount and to prevent user errors.

According to the disclosed embodiment, there is an effect of providing an interface that allows the user to freely switch a scheme to enter the remittance amount.

According to the disclosed embodiment, there is an effect of automatically round-downing an unnecessary small amount and of guiding the user to deposit or donate the unnecessary small amount.

According to the disclosed embodiment, there is an effect that the present approach can give confidence to the user by displaying the remittance histories of other users in real time.

The effects of the inventive concept are not limited to the effects mentioned above. Other effects not mentioned will be clearly understood by those skilled in the art from the above description.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for providing a user interface for overseas remittance between a first country and a second country, the method comprising:
displaying the first country and the second country;
displaying a first user interface for setting a remittance amount;
displaying a second user interface for setting a received amount;
receiving a user input to one of the first user interface and the second user interface;
calculating an amount corresponding to the other user interface from an amount corresponding to the one user interface; and
displaying the calculated amount in the other user interface.

2. The method of claim 1, wherein each of the first user interface and the second user interface includes a jog bar for receiving a touch input or a sliding input of an amount in a predefined range.

3. The method of claim 1, wherein the method further comprises:
receiving an input for changing an amount displayed in one of the first user interface and the second user interface;
calculating a remittance fee corresponding to the changed amount; and
changing a display of at least one of the first user interface and the second user interface based on an amount of the calculated remittance fee.

4. The method of claim 1, wherein the method further comprises:
displaying a graph representing fluctuations of an exchange rate between a currency of the first country and a currency of the second country for a predefined period;
displaying, in the graph, one or more time points at which the user performed remittances; and
displaying information about a remittance amount and an exchange rate at the one or more time points.

5. The method of claim 1, wherein the method further comprises:
obtaining a target type;
obtaining an amount corresponding to the obtained target type; and
displaying a cumulative saved remittance fee for a predefined period in a compared manner with the obtained amount.

6. The method of claim 1, wherein the method further comprises:
displaying an amount input window and an amount display window;
displaying a dropdown box for selecting one of a first mode and a second mode;
applying one of the first mode and the second mode based on an user input to the dropdown box;
when the first mode is applied, receiving, by the amount input window, a remittance amount from a remitter of the first country to a recipient of the second country in a currency of the first country, and displaying, in the amount display window, an amount to be received by the recipient of the second country in a currency of the second country;
when the second mode is applied, receiving, by the amount input window, an amount to be received by the recipient of the second country in a currency of the second country, and displaying, in the amount display window, an amount to be remitted by the remitter of the first country in a currency of the first country.

7. The method of claim 6, wherein the method further comprises:
when the first mode is applied,
extracting an amount smaller than or equal to a predefined amount from the amount displayed in the amount display window;
displaying a button for selecting whether to round-down the extracted amount; and
when a selection input of the button is received, remitting the extracted amount round-downed from the amount displayed in the amount display window to the recipient of the second country.

8. The method of claim 7, wherein the displaying of the button includes displaying a deposit button for depositing the extracted amount and a donation button for donating the extracted amount,
wherein the method further comprises:
when a selection input of the deposit button is received, depositing the extracted amount to the remitter of the first country; and
when a selection input of the donation button is received, donating the extracted amount.

9. The method of claim 6, wherein the method further comprises:
sequentially obtaining remittance histories of other remitters;
removing personal information from each remittance history to generate a displayed remittance history; and
sequentially displaying the generated displayed remittance histories.

10. An application stored on a computer-readable recording medium for carrying out the method of claim 1.
